(19) United States
(12) Patent Application Publication
(10) Pub. No.: US 2014/0049029 A1
(43) Pub. Date: Feb. 20, 2014

(54) STEERING COLUMN FOR A WORK VEHICLE WITH INTEGRAL ADJUSTABLE FOOT RESTS

(71) Applicant: CNH America LLC, New Holland, PA (US)

(72) Inventors: William K. Dooley, Romeoville, IL (US); Steven S. Savov, Algonquin, IL (US); Eric M. Jacobsthal, Elmhurst, IL (US); David C. Sachtleben, Bolingbrook, IL (US); Aaron R. Richard, Berwyn, IL (US); Jesse W. Gonzales, Falls Church, VA (US); Peter J. Zerillo, Chicago, IL (US)

(73) Assignee: CNH America LLC, New Holland, PA (US)

(21) Appl. No.: 13/969,234

(22) Filed: Aug. 16, 2013

Related U.S. Application Data
(60) Provisional application No. 61/742,695, filed on Aug. 16, 2012.

(51) Int. Cl. B62D 1/189

(52) U.S. Cl. CPC B62D 1/189
USPC 280/775; 280/771

(57) ABSTRACT

A work vehicle includes a chassis, an operator station, and a steering column. The operator station is carried by the chassis and includes a floor. The steering column is mounted to and extends upward from the floor. The steering column includes a pair of opposite sides and a pair of foot rests, with each foot rest extending laterally outward from a respective side. The position of the foot rests is preferably adjustable.

### CROSS REFERENCE TO RELATED APPLICATIONS

This is a non-provisional application based upon U.S. provisional patent application Ser. No. 61/742,695, entitled “COMMON CAB CENTER CONSOLE PEGS UTILITY PATENT”, filed Aug. 16, 2012, which is incorporated herein by reference.

### BACKGROUND OF THE INVENTION

1. Field of the Invention

The present invention relates to vehicles, and, more particularly, to vehicles including a floor mounted steering column.

2. Description of the Related Art

Work vehicles may include agricultural, construction, forestry or industrial vehicles. Work vehicles such as agricultural tractors or combines typically include an operator station with a seat, console and steering wheel. The console includes a number of actuators such as switches, throttle lever and hydraulic levers allowing the operator to control operation of the work vehicle. The steering wheel may be mounted to a dash arrangement, or alternatively mounted to a steering column which extends from and is mounted with the floor of the operator station. A foot clutch or hydrostatic foot pedal may be mounted to the left of the steering column, and left and right brake pedals may be mounted to the right of the steering column.

It is common for an operator to spend long hours in a work vehicle while working or harvesting a field. Fatigue can become an issue, and moving or repositioning the operator's body within the operator station to whatever extent is possible may help to reduce fatigue. Typically the feet of the operator are simply placed on the floor behind the steering column. It is usually not desirable to place the feet on the clutch or brake pedals since these components can be sensitive and just the weight of the feet can affect operation. In the case of a hydrostatic pedal, some are designed to allow the left foot to be removed while maintaining the pedal at the selected position, while others are biased to return the pedal to a neutral position and require that the foot remain on the pedal. In any event, movement of the operator's feet within the operator station is very limited and fatigue can sometimes occur.

What is needed in the art is an operator station which is configured to allow additional movement of the operator to alleviate the effects of fatigue during long days in the field.

### SUMMARY OF THE INVENTION

The present invention provides a steering column for a work vehicle which includes a pair of foot rests extending laterally outward from each side of the steering column, with the position of the foot rests preferably being adjustable.

The invention in one form is directed to a work vehicle including a chassis, an operator station, and a steering column. The operator station is carried by the chassis and includes a floor. The steering column is mounted to and extends upward from the floor. The steering column includes a pair of opposite sides and a pair of foot rests, with each foot rest extending laterally outward from a respective side.

An advantage of the present invention is that the an alternative position is provided for the feet of an operator.

Another advantage is that this additional placement location of the feet can alleviate fatigue during long days operating the vehicle.

Still another advantage is that the placement location of the foot rests is adjustable.

Yet another advantage is that the foot rests provide improved visibility from the front window, and improved knee and leg clearance.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic side view of a work vehicle in the form of an agricultural combine, including an embodiment of a steering column of the present invention;

FIG. 2 is a perspective view of the steering column used in the combine of FIG. 1, including integral foot rests;

FIG. 3 is another perspective view of the steering column shown in FIG. 2;

FIG. 4 is a rear view of the steering column shown in FIGS. 2 and 3;

FIG. 5 is a side view of the steering column shown in FIGS. 2-4; and

FIG. 6 is a top view of the steering column shown in FIGS. 2-5.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

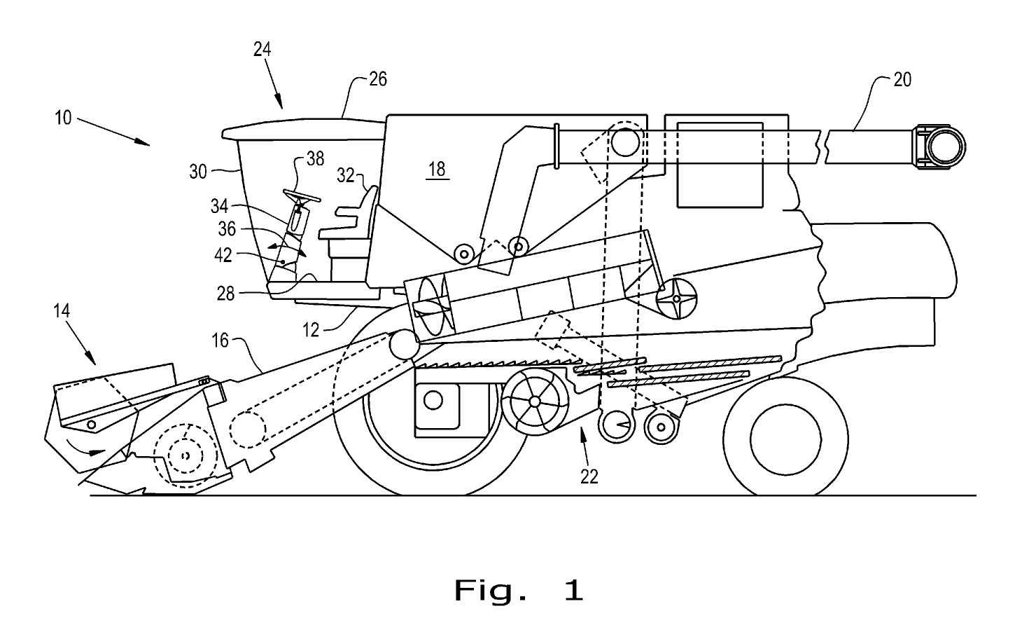

Referring now to the drawings, and more particularly to FIG. 1, there is shown a work vehicle in the form of an agricultural combine 10 which generally includes a chassis 12, header 14, feeder housing 16, clean grain tank 18 and unloading auger 20. Combine 10 also includes internal sub-systems 22 in the form of threshing, separating and cleaning systems for producing clean grain. All of these components may be conventional in design and are not described further herein for simplicity sake.

Combine 10 also includes an operator station 24 which is carried by chassis 12. In the illustrated embodiment, operator station 24 includes a cab 26 for environmental control of the ambient environment in which the operator is located. Cab 26 includes a floor 28 and a number of glass windows 30 providing adequate visibility for the operator. An operator seat 32 is attached to the floor 28 against a rear wall of cab 26. A steering column 34 is mounted to and extends upwardly from floor 28. Steering column 34 is pivotally movable in fore-to-aft directions (as indicated by the double headed arrow 36), and includes a steering wheel 38 at the top thereof.

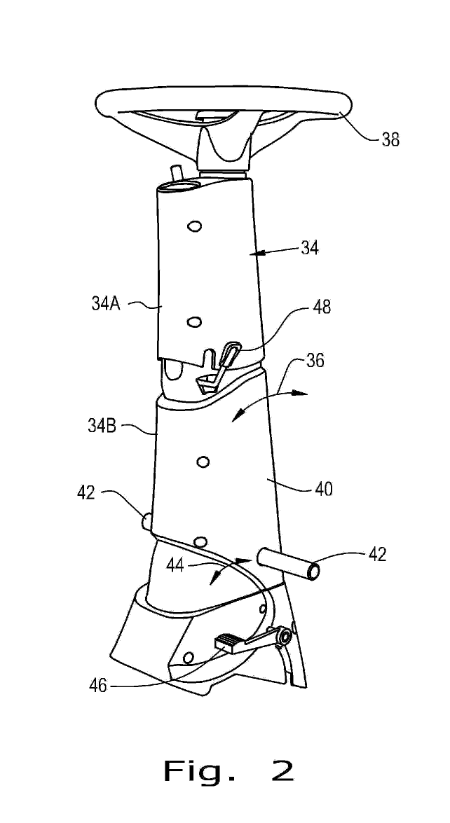

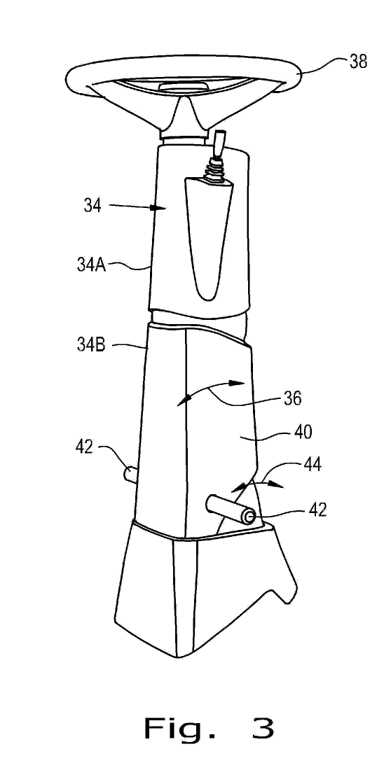

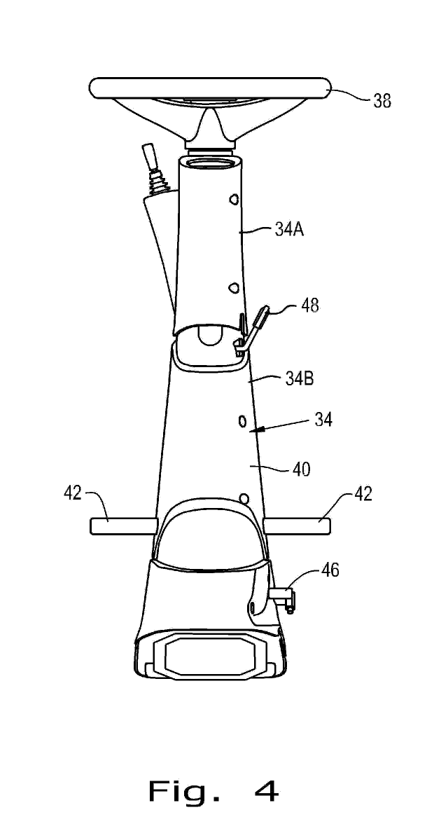

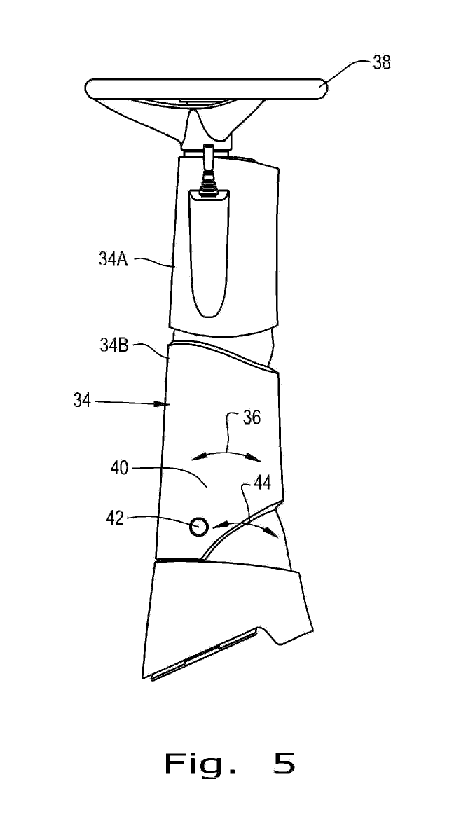

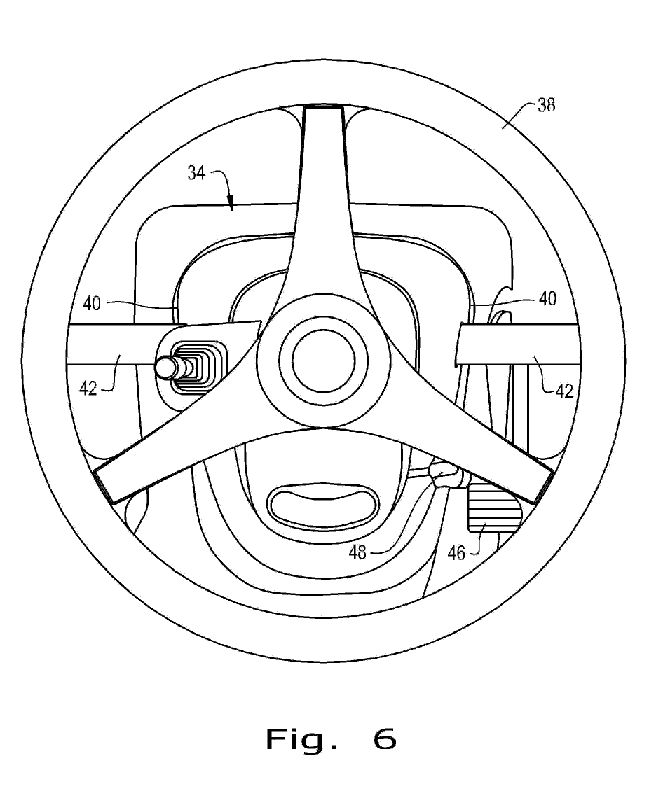

According to an aspect of the present invention, and referring now to FIGS. 1-6, conjunctively, steering column 34 includes a pair of sides 40 and a pair of foot rests 42 which extend laterally outward from each respective side 40. Foot rests 42 are attached to and positioned on steering column 34 such that pivotal movement of steering column 34 in the fore-to-aft directions also results in fore-to-aft movement of foot rests 42 along an arcuate path 44.

In the illustrated embodiment, foot rests 42 are actually attached to the sides 40 and extend laterally therefrom. However, is also possible to form aligned openings in the sides 40 and use a single rod which extends through the aligned openings to define the foot rests 42. Moreover, in the illustrated embodiment, foot rests 42 are in the form of foot pegs, but it is to be understood that other types of foot rests may also be used.

Steering column 34 may be segmented with an upper column section 34A and a lower column section 34B (as shown), or may be a unitary column (not shown). The lower column section 34B is pivotally movable relative to the floor 28 to allow selection of a preferred foot rest position, and the upper column section 34A is pivotally movable relative to the lower column section 34B to allow selection of a preferred arm position of the operator. A hand release 48 is actuated to allow the pivotal movement between upper column section 34A and lower column section 34B, and is then returned to a lock position to lock the relative angular orientation between upper column section 34A and lower column section 34B.

During use, lower column section 50 of steering column 34 may be tipped forward or rearward by stepping on a foot release 46 at the bottom of steering column 34. As the steering column 34 is moved forward or rearward, foot rests 42 move along arcuate path 44. When the steering column 34 is at a desired location, the foot is removed from foot release 46 to lock steering column 34 in place. Hand release 48 is actuated to allow the upper column section 34A to be pivoted relative to lower column section 34B, and is then returned to the lock position at a desired arm position of the operator. An operator may place one or both feet on the foot rests 42 as desired.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A work vehicle, comprising:
a chassis;
an operator station carried by said chassis, said operator station including a floor; and
a steering column mounted to and extending upward from said floor, said steering column including a pair of opposite sides and a pair of foot rests, each said foot rest extending laterally outward from a respective said side.

2. The work vehicle of claim 1, wherein said steering column is pivotally movable in a fore-to-aft direction and includes a steering wheel at a top thereof, and said pair of foot rests are mounted to said steering column so as to also move in the fore-to-aft direction upon pivotal movement of said steering column.

3. The work vehicle of claim 2, wherein said pair of foot rests are mounted to said steering column so as to move in an arcuate path upon pivotal movement of said steering column.

4. The work vehicle of claim 2, wherein said steering column is segmented with an upper column section and a lower column section, said lower column section being pivotally movable relative to said floor to allow selection of a preferred foot rest position, and said upper column section being pivotally movable relative to said lower column section to allow selection of a preferred arm position of an operator.

5. The work vehicle of claim 1, wherein each said foot rest is attached to a respective said side of said steering column.

6. The work vehicle of claim 1, wherein each said foot rest is a foot peg.
